(19) United States
(12) Patent Application Publication
(10) Pub. No.: US 2010/0039551 A1
(43) Pub. Date: Feb. 18, 2010

(54) DIGITAL IMAGE CAPTURE DEVICE AND EXPOSURE METHOD THEREOF

(75) Inventor: ZHENG-GANG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,785

(22) Filed: Dec. 30, 2008

(30) Foreign Application Priority Data
Aug. 15, 2008 (CN) 200810303904.6

(51) Int. Cl. H04N 5/238

(52) U.S. Cl. 348/364; 348/E05.04

(57) ABSTRACT

An exposure method is disclosed. Correct exposure settings are determined for an object in a scene. The determined exposure settings include an exposure time. Whether any portion of an image of the scene formed using the determined exposure settings is overexposed or underexposed is detected. Adjustment times of photometers of an image sensor corresponding to the over/underexposed region(s), if any, to the exposure time are calculated. The calculated adjustment times are converted into regional exposure time(s) for the over/underexposed region(s). The image sensor is exposed using the exposure time and the regional exposure time(s).

### BACKGROUND

1. Technical Field

The present disclosure relates to image capture devices and, particularly, to a digital image capture device which can obtain correct exposure settings for the entire scene, even in extremely high contrast light conditions, and an exposure method thereof.

2. Description of the Related Art

Digital image capture devices typically include an image sensor. The image sensor includes a matrix of photometers, each of which is configured for sensing light impinging thereon and thereby determining brightness of an image pixel corresponding to that photometer. When using such a digital image capture device to capture images of an extremely high contrast scene, in order to obtain correct exposure for object in the scene, exposure for the remaining portion(s) in the scene are neglected, resulting in over or under exposed portion(s) in a final image of the scene.

Therefore, it is desirable to provide a digital image capture device and an exposure method thereof that can overcome the above-mentioned problem.

### BRIEF DESCRIPTION OF THE DRAWINGS

FIG. 1 is a schematic view of a digital image capture device, according to an exemplary embodiment.

FIG. 2 is a flowchart of an exposure method, according to another exemplary embodiment.

### DETAILED DESCRIPTION OF THE EMBODIMENTS

Embodiments of the present digital image capture device and exposure method thereof will be described in detail below with reference to the drawings.

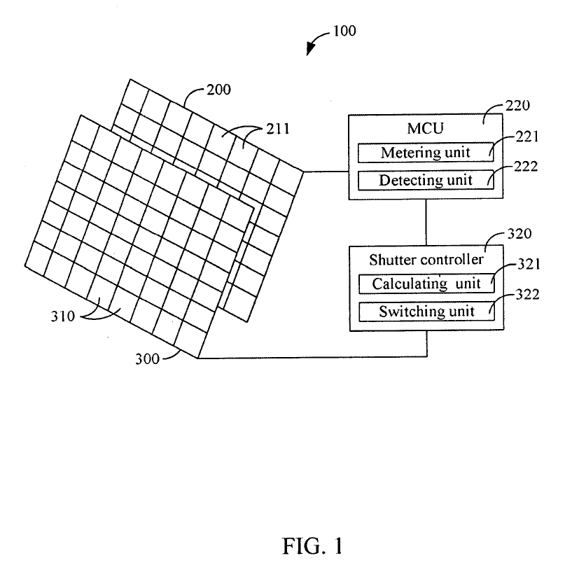

Referring to FIG. 1, a digital image capture device 100, such as a digital still camera or any other electronic device equipped with a camera module, includes an image sensor 200, a micro control unit (MCU) 220, a matrix shutter 300, and a shutter controller 320.

The image sensor 200 such as a charge-coupled device (CCD) or a complementary metal oxide semiconductor (CMOS) is for converting light incident thereon into a corresponding image. The image sensor 200 includes a matrix of photometers 211, each of which is configured for sensing light impinging thereon and thereby determining an image pixel value of the image. Also, in other alternative embodiments, one image pixel value can be determined by several photometers.

The MCU 220 includes a metering unit 221 and a detecting unit 222. The metering unit 221 is configured for measuring light in the scene to determine correct exposure settings for the object in the scene. Typically, the exposure settings include an exposure time. However, exposure for the remaining portion(s) in the scene may be neglected when the image sensor 200 is exposed using the determined exposure settings and is therefore over/under exposed. The detecting unit 222 is configured for detecting whether the image formed using the determined exposure settings includes any over/under exposed region and locating the over/under exposed region(s), if any. In detail, the detecting unit 222 reads brightness of an image pixel and judges whether the read brightness is greater/smaller than a predetermined brightness. If yes, that image pixel is over/under exposed.

The matrix shutter 300 is placed in front of the image sensor 200, and includes a matrix of light valves 310, each of which is dedicated for controlling the exposure time of a corresponding photometer 211.

The shutter controller 320 includes a calculating unit 321 and a switching unit 322. The calculating unit 321 is configured for calculating exposure times of the corresponding photometers 211. The switching unit 322 is configured for switching the light valves 310 on/off and thereby controlling the light valves 310 to expose the corresponding photometers 211 with corresponding exposure times.

In this embodiment, the matrix of light valves 310 is integrated into a transmissive light crystal display (LCD) panel, which is placed in immediate front of the image sensor 200. Each light valve 310 is essentially similar to a corresponding photometer 211 in shape and aligned with the corresponding photometer 211. The calculating unit 321 calculates the exposure time of a photometer 211 using the formulas:

Tᵥ+Aᵥ=Bᵥ+Sᵥ,

Tᵥ′+Aᵥ=Bᵥ′+Sᵥ, and

ΔT=Tᵥ−Tᵥ′

where Tᵥ, Aᵥ, Bᵥ and Sᵥ are a correct exposure time for the photometer 211, an aperture value of the digital image capture device 100, a predetermined desired brightness value, and a sensitivity value of the image sensor 200, respectively, Tᵥ′ and Bᵥ′ are the exposure time and an brightness value of the photometer 211 when the image sensor 200 is exposed using the determined exposure settings respectively, and ΔT is an adjustment time of the photometer 211 to the exposure time. The switching unit 322 is an LCD panel driver.

In operation, the matrix of light valves 310 can be controlled to expose the image sensor 200 region by region. The exposure time of a region is the average of the exposure times regarding the photometers 211 of that region. For example, the exposure time for the object is the exposure time of the determined exposure settings. The exposure time of a region T which is over/underexposed by the determined exposure settings is determined by the formula:

T=Tᵥ′+ Δ̅T̅,

Where Δ̅T̅ is the average of the adjustment times for photometers in that region.

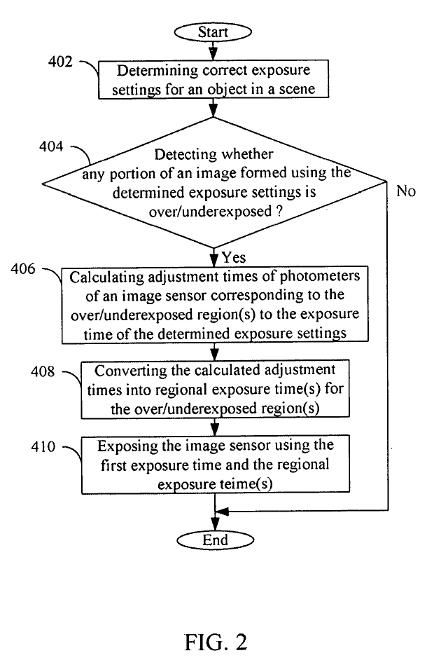

Referring to FIG. 2, an exposure method, according to another exemplary embodiment, can be implemented by the digital image capture device 100 and includes the following steps 402-410.

Step 402: determining correct exposure settings of an object of interest. This step can be carried out by the metering unit 221 (see above). The determined exposure settings include an exposure time.

Step 404: detecting whether any portion of an image formed using the determined exposure settings is over/under exposed. This step can be carried out by the detecting unit 222 (see above).

Step 406: calculating adjustment times of photometers of an image sensor corresponding to the over/under exposed region(s), if any, to the exposure time of the determined exposure settings. This step can be carried out by the calculating unit 321 (see above).

Step 408: converting the calculated adjustment times into regional exposure time(s) for the over/under exposed region(s). This step also can be carried out by the calculating unit 321.

Step 410: capturing an image using the first exposure time and the regional exposure time(s). This step can be carried out by the image sensor 200, the matrix shutter 300, and the switching unit 322 (see above).

The digital image capture device 100 can expose the image sensor to a scene having extremely different brightness using different exposure times, i.e., the exposure time of the determined exposure settings and the regional exposure time(s), thereby obtain correct exposure for the entire scene.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A digital image capture device comprising:
an image sensor comprising a matrix of photometers each being configured for converting light from a scene impinging thereon into a corresponding image pixel value;
a metering unit configured for metering light in the scene and accordingly determining correct exposure settings for an object in a scene, the determined settings comprising an exposure time;
a detecting unit configured for detecting whether an image formed by the image sensor using the determined t exposure settings contains any overexposed or underexposed region;
a calculating unit configured for calculating adjustment times of photometers corresponding to the overexposed or underexposed region(s), if any, and thereby calculating regional exposure time(s) for the overexposed or underexposed region(s);
a matrix shutter comprising a matrix of light valves each being configured for controlling the exposure time of a corresponding photometer;
a switching unit configured for switching the light valves on and off to expose the photometers corresponding to the object with the exposure time and photometers corresponding to the overexposed or underexposed region(s) with the regional exposure time(s).

2. The digital image capture device as claimed in claim 1, wherein the image sensor is selected from the group consisting of a charge-coupled device and a complementary metal oxide semiconductor.

3. The digital image capture device as claimed in claim 1, wherein the metering unit and the detecting unit is integrated into a micro control unit.

4. The digital image capture device as claimed in claim 1, wherein the detecting unit detects whether an image pixel is overexposed by judging whether the value of the image pixel is greater than a predetermined value.

5. The digital image capture device as claimed in claim 1, wherein the detecting unit detects whether an image pixel is underexposed by judging whether the value of the image pixel is smaller than a predetermined value.

6. The digital image capture device as claimed in claim 1, wherein the matrix shutter is placed in front of the image sensor, each of the light valves being similar to a corresponding photometer in shape and aligned to the corresponding photometer.

7. The digital image capture device as claimed in claim 1, wherein the matrix shutter comprises a transmissive liquid crystal display panel.

8. The digital image capture device as claimed in claim 1, wherein the calculating unit and the switching unit are integrated into a chip.

9. The digital image capture device as claimed in claim 1, wherein the switching unit comprises a liquid crystal display driver.

10. The digital image capture device as claimed in claim 1, wherein the calculating unit calculates the adjustment exposure time for a photometer using the formulas:
Tᵥ+Aᵥ=Bᵥ+Sᵥ,
Tᵥ′+Aᵥ=Bᵥ′+Sᵥ, and
ΔT=Tᵥ−Tᵥ′
where Tᵥ, Aᵥ, Bᵥ and Sᵥ are a correct exposure time for the photometer, an aperture value of the digital image capture device, a predetermined desired brightness value, and a sensitivity value of the image sensor respectively, Tᵥ′ and Bᵥ′ are an exposure time and an brightness value of the photometer when the image sensor is exposed using the determined exposure settings respectively, and ΔT is the adjustment time.

11. The digital image capture device as claimed in claim 1, wherein the calculating unit calculates regional exposure time for an overexposed or underexposed region using the formula:
T=Tᵥ′+ Δ̅T̅.
where T is the regional exposure time, Tᵥ′ is the exposure time, Δ̅T̅ is the average of adjustment times of the photometers in the region.

12. An exposure method comprising:
determining correct exposure settings for an object in a scene, the determined exposure setting comprising an exposure time;
detecting whether an image of the scene formed using the determined exposure settings comprises any overexposed or underexposed portion;
calculating adjustment times of photometers of an image sensor corresponding to the overexposed or underexposed region(s), if any, to the exposure time;
converting the calculated adjustment times into regional exposure time(s) for the overexposed or underexposed region(s); and
capturing an image using the exposure time for the object and regional exposure time(s) for the remaining portion(s) in the scene.

13. The exposure method as claimed in claim 12, wherein the detecting step detect whether an image pixel is overexposed by judging whether the value of the image pixel is greater than a predetermined value.

14. The exposure method as claimed in claim 12, wherein the detecting step detect whether an image pixel is overexposed by judging whether the value of the image pixel is greater than a predetermined value.

15. The exposure method as claimed in claim 12, wherein the calculating step calculates the adjustment exposure time for a photometer using the formulas:
Tᵥ+Aᵥ=Bᵥ+Sᵥ,
Tᵥ′+Aᵥ=Bᵥ′+Sᵥ, and
ΔT=Tᵥ−Tᵥ′
where Tᵥ, Aᵥ, Bᵥ and Sᵥ are a correct exposure time for the photometer, an aperture value, a predetermined desired brightness value, and a sensitivity value of the image sensor respectively, Tᵥ′ and Bᵥ′ are an exposure time and an brightness value of the photometer when the image sensor is exposed using the determined exposure settings respectively, and ΔT is the adjustment time.

16. The exposure method as claimed in claim 12, wherein the converting step converts the adjustment times of photometer of an overexposed or underexposed region into a regional exposure time using the formula:
T=Tᵥ′+ Δ̅T̅.
where T is the regional exposure time, Tᵥ′ is the exposure time, Δ̅T̅ is the average of adjustment times of the photometers in the region.
